(19) United States
(12) Patent Application Publication
(10) Pub. No.: US 2018/0239697 A1
(43) Pub. Date: Aug. 23, 2018

(54) METHOD AND APPARATUS FOR PROVIDING MULTI-NAMESPACE USING MAPPING MEMORY

(71) Applicant: CNEXLABS, Inc. a Delaware Corporation, San Jose, CA (US)

(72) Inventors: Yiren Ronnie Huang, San Jose, CA (US); David Hansen Geddes, Fremont, CA (US)

(21) Appl. No.: 15/439,779

(22) Filed: Feb. 22, 2017

(51) Int. Cl. G06F 12/02; G06F 12/109

(52) U.S. Cl. CPC G06F 12/0246; G06F 12/109; G06F 2212/7201; G06F 2212/2022; G06F 2212/1044

(57) ABSTRACT

A method and/or apparatus capable of storing information in non-volatile memory with multiple namespaces is disclosed. The method or apparatus, in one aspect, includes a translation table, a global LBA table, and a FTL table wherein the translation table is also known as namespace translation table. The translation table, in one example, includes multiple entries wherein each entry stores translated information relating to translation between an incoming logical block address (“LBA”) with namespace identifiers (“NSIDs”) and a translated LBA (“TR_LBA”). The global LBA table, in one aspect, has multiple global entries, wherein each global entry stores a global LBA base unit generated in response to a TR_LBA. The FTL table contains multiple FTL entries, wherein each FTL entry includes a physical page address (“PPA”) indexed by a global LBA base unit. The apparatus is capable of facilitating memory access based on the PPA.

### FIELD

The exemplary embodiment(s) of the present invention relates to the field of semiconductor and integrated circuits. More specifically, the exemplary embodiment(s) of the present invention relates to non-volatile (“NV”) storage devices.

### BACKGROUND

With increasing popularity of electronic devices, such as computers, smart phones, mobile devices, server farms, mainframe computers, and the like, the demand for more and faster data is constantly growing. To handle and facilitate voluminous data between such electronic devices, high speed NV memory devices are typically required. A conventional type of NV memory device, for example, is a flash memory based storage device such as solid-state drive (“SSD”).

The flash memory based SSD, for example, is an electronic NV computer storage device capable of maintaining, erasing, and/or reprogramming data. The flash memory can be fabricated with several different types of integrated circuit (“IC”) technologies such as NOR or NAND logic gates with, for example, floating-gate transistors. Depending on the applications, a typical memory access of flash memory can be configured to be a block, a page, a word, and/or a byte.

A drawback associated with a typical SSD is that the SSD may experience data integrity or data security issues when the drive is shared by multiple independent users via, for instance, multiple virtual machines (“VMs”). A conventional drive, for example, can be susceptible to data security guarantee between active users or VMs. In addition, a typical drive can be vulnerable to space allocation as well as recycling during accessing by multiple users.

In a typical NVME endpoint device, the least significant bits of the namespace (“NS”), for example, may be concatenated with LBA in order to derive a unique identifier for indexing a block for user data. A unique identifier, for instance, might be created by combining four bits of NS information with 28-bits of LBA, as illustrated in the following formula:

Unique-Id[31:0]=NS[3:0],LBA[27:0]

One shortcoming of this method is that it may result in a significant amount of internal fragmentation in the FTL. This fragmentation occurs when the size of the user NS is not an even power of 2. For example, if the size of user NS is less than 256M LBAs, the unused space may be wasted. In other words, a gap may exist in the FTL equal to the size of the unused space.

### SUMMARY

One embodiment of the presently claimed invention discloses an apparatus or process capable of storing information in non-volatile memory (“NVM”) with multiple namespaces (“MNS”) managed by a flash translation layer (“FTL”) process. The apparatus, in one aspect, includes a translation table, a global LBA table, and a FTL table wherein the translation table is also known as namespace (“NS”) translation table. The translation table, in one example, includes multiple entries wherein each entry stores translated information relating to translation between an incoming logical block address (“LBA”) with namespace identifiers (“NSIDs”) and a translated LBA (“TR_LBA”). The global LBA table, in one aspect, is configured to have multiple global entries, wherein each global entry stores a global LBA base unit generated in response to a TR_LBA. The FTL table contains multiple FTL entries, wherein each FTL entry includes a physical page address (“PPA”) indexed by a global LBA.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a computer system capable of providing virtual solid state drives (“VSSD”) to support its virtual machines (“VMs”) using multi-namespace (“MNS”) in accordance with one embodiment of the present invention;

FIG. 2 is a block diagram illustrating a non-volatile (“NV”) storage device capable of providing MNS managed by a flash translation layer (“FTL”) in accordance with one embodiment of the present invention;

FIGS. 3A-B are logic block diagrams illustrating MNS implementations using tables in accordance with one embodiment of the present invention;

FIG. 4 is a block diagram illustrating an NVM storage controller configured to provide MNS in accordance with one embodiment of the present invention;

FIG. 5 is a logic diagram illustrating a logic representation of translated LBA (“TR_LBA”) for NSID translation in accordance with one embodiment of the present invention;

FIG. 6 is a diagram illustrating mapping tables or mapping memory for MNS operation in accordance with one embodiment of the present invention;

FIG. 7 is a logic diagram illustrating a process of mapping TR_LBA to GLB units in accordance with one embodiment of the present invention;

FIGS. 8A-D are logic diagrams illustrating an exemplary process showing an MNS operation in accordance with one embodiment of the present invention;

FIG. 9 is a block diagram illustrating a digital processing system capable of providing MNS operation in accordance with one embodiment of the present invention; and

FIG. 10 is a flow diagram illustrating an operation of MNS using memory mapping in accordance with one embodiment of the present invention.

### DETAILED DESCRIPTION

Embodiments of the present invention are described herein with context of a method and/or apparatus for storing information according to different namespace identifiers (“NSID”) in SSD.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

One embodiment of the presently claimed invention discloses an apparatus or process capable of storing information in non-volatile memory (“NVM”) with multiple namespaces (“MNS”) managed by a flash translation layer (“FTL”) process. The apparatus, in one aspect, includes a translation table, a global LBA table, and a FTL table wherein the translation table is also known as namespace (“NS”) translation table. The translation table, in one example, includes multiple entries wherein each entry stores translated information relating to translation between an incoming logical block address (“LBA”) with namespace identifiers (“NSIDs”) and a translated LBA (“TR_LBA”). The global LBA table, in one aspect, is configured to have multiple global entries, wherein each global entry stores a global LBA base unit generated in response to a TR_LBA. The FTL table contains multiple FTL entries, wherein each FTL entry includes a physical page address (“PPA”) indexed by a global LBA. The apparatus is capable of facilitating memory access based on the PPA.

During an operation, a process of facilitating MNS in SSD using FTL receives a memory access request with an LBA in first NSID or NS(1). Upon looking up the first LBA offset in the NS translation table according to the first NSID, a first TR_LBA is generated based at least partially on first LBA offset. After identifying a first LBA base unit in a mapping table in accordance with an index generated from a portion of bits of the first TR_LBA, a first Global LBA is generated from a portion of the bits of the mapping table combined with a portion of bits of the TR_LBA. A first PPA is subsequently obtained or located at the FTL table in response to the first Global LBA. The memory access request is carried out in accordance with the PPA.

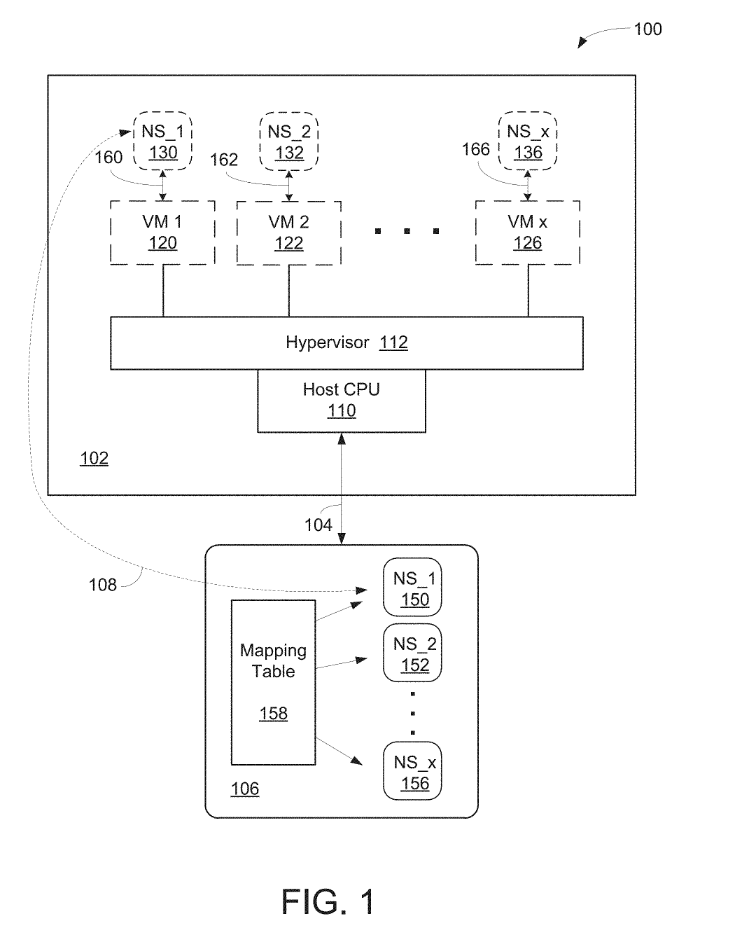

FIG. 1 is a block diagram 100 illustrating a computer system containing one SSD capable of providing virtual SSD (“VSSD”) for supporting virtual machines (“VMs”) using multi-namespace (“MNS”) in accordance with one embodiment of the present invention. Diagram 100 includes computer system 102, SSD 106, and bus 104 wherein bus 104, in one aspect, is a high-speed memory bus, such as, but not limited to, a peripheral component interconnect express (“PCIe”) bus, a serial Advanced Technology Attachment (“ATA”) bus, a Universal Serial Bus (“USB”), a parallel ATA bus, a small computer system interface (“SCSI”), FireWire, Fibre Channel, a PCIe Advanced Switching (“PCIe-AS”) bus, a network, Infiniband, SCSI RDMA, or the like. System 102, in one example, includes host central processing unit (“CPU”) and hypervisor 112 and is capable of launching multiple virtual machines (“VMs”) 120-126. It should be noted that the underlying concept of the exemplary embodiment(s) of the present invention would not change if one or more blocks (or devices) were added to or removed from diagram 100.

Computer system 102, in one example, can be a personal computer, server, network system, smart phone, wireless hub, base station, mainframe computer, and/or any digital processing system capable of executing instruction. System 102 is able to dynamically launch, maintain, and terminate various VMs 120-126 concurrently using virtual machine firmware or software 112 such as hypervisor. In one aspect, VMs 120-126 are virtually allocated their own VSSD 130-136 via virtual memory buses 160-166 using different name spaces or NSs.

It should be noted that VM is a software emulation that mimics an independent computer system capable of providing functions generally performed by a computer system. To an end user, VM has its own hardware, operating system(s), and application(s). To launch a VM, it usually includes a virtual hardware, guest operating system(s), and intended application(s). For example, a VM support program such as hypervisor may use native execution to share and manage hardware and facilitate concurrent operations to support multiple computing environments. The multiple computing environments or VMs are isolated from one another while supported on one physical machine. In this embodiment, each VM such as VM1 120 is coupled to a virtual SSD or VSSD such as VSSD 130 via a virtual memory bus such as bus 160.

To support VSSD operation, MNS is used to facilitate virtual SSD operations. SSD 106, in one embodiment, is configured to handle VSSD via MNS operations. SSD 106, for example, includes multiple NSs 150-156 wherein each NS is addressed by NSID. ID for NS 150, for instance, can be one (1) or designated as NS-1, NS(1), or NS_1. SSD 106 also includes a mapping table 158 which is used to map VSSD 130-136 to multiple NSs 150-156. For example, NS-1 150 in SSD 106 is mapped to VSSD 130 as indicated by dotted arrow 108.

An advantage of using MNS is that it efficiently uses physical SSD storage space to support VSSD operation. Another advantage of using MNS is that it provides better drive security and data integrity.

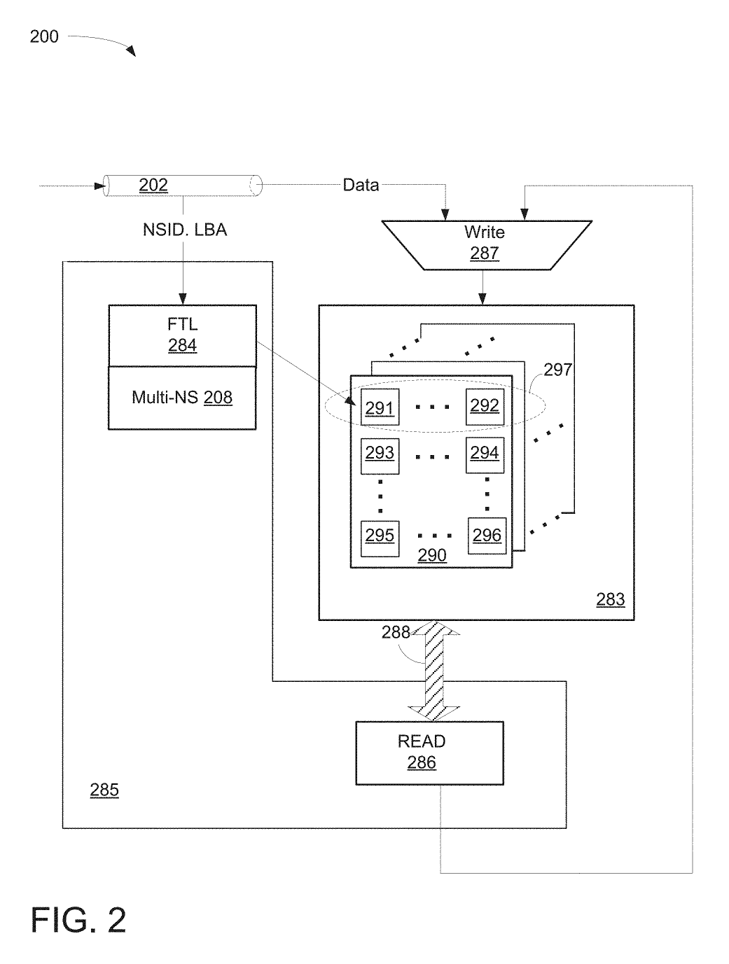

FIG. 2 is a block diagram 200 illustrating a non-volatile (“NV”) storage device capable of providing MNS via FTL in accordance with one embodiment of the present invention. Diagram 200 includes input data 202, storage device 283, output port 288, and storage controller 285. Storage controller 285 further includes read module 286, FTL 284, MNS module 208, and/or write module 287. A function of FTL 284 is, for example, to map LBA to physical address(s). It should be noted that the underlying concept of the exemplary embodiment(s) of the present invention would not change if one or more blocks (or devices) were added to or removed from diagram 200.

MNS module 208, which could be part of FTL 284, is configured to implement and/or facilitate multiple namespaces operating on one (1) physical storage drive. To facilitate multiple namespaces, the physical storage space in the drive is divided into multiple storage base units wherein one or more base units can be assigned or allocated to a namespace. A function of MNS module 208 is to keep track and/or map a namespace identifier or NSID such as NS_1 to a base unit.

Storage device 283, in one embodiment is a flash based NVM which includes multiple arrays of flash memory cells for storing data persistently. The flash memory, which generally has a read latency less than 200 microseconds (“μs”), is organized in blocks and pages wherein a minimum access unit, for example, can be set to four (4) kilobyte (“Kbyte”), eight (8) Kbyte, or sixteen (16) Kbyte memory capacity depending on the flash memory technologies. To simplify forgoing discussion, a four (4) Kbyte page or flash memory page (“FMP”) is used.

Referring back to FIG. 2, storage device 283 is organized into multiple NVM blocks or blocks 290 wherein each block such as block 290 further includes a set of pages or FMPs 291-296. Each page such as page 291, for example, has a capacity or size capable of storing 4096 bytes or 4 Kbyte of information. Each block such as block 290, in one example, may contain a range of pages from 128 to 512 pages (or sectors) 291-296. A page, in one example, is generally a minimal writable or readable unit while a block is a minimal number to perform an erase function. Flash memory 283 can persistently retain information or data for a long period of time without power supply.

FTL 284, which may be implemented in DRAM, includes a FTL database or table that stores mapping information. For example, the size of FTL database is generally a positive proportion to the total size of SSD storage capacity. For instance, one way to implement the FTL in SSD is that it uses a DRAM size that approximately equals to 1/1000 of SSD capacity. For example, because each page has a 4-Kbyte capacity, and each entry of FTL database has a 4-byte capacity of entry, the size of FTL database can be calculated as SSD capacity/4 KByte*4 Byte (SSD capacity/1000) which is approximately 1 over 1000 (or 1/1000).

In operation, upon receipt of data input or data packets 202 containing NSID.LBA, FTL 284 translates NSID.LBA to a physical page address (“PPA”) using NS translation table and the mapping table. After identifying PPA, write circuit 287 writes the data from data packets 282 to a page or pages within a block pointed by PPA. In one example, MNS 208 may allocate or divide storage space into basic storage units wherein the storage capacities for the basic storage units are essentially the same or similar. Based on the size of the namespace, one or more basic storage units can be assigned or allocated to one NSID.

It should be noted that storage device 283 can also include NAND flash memory, NOR flash memory, phase change memory (“PCM”), nano random access memory (“NRAM”), magneto-resistive RAM (“MRAM”), resistive random-access memory (“RRAM”), programmable metallization cell (“PMC”), magnetic storage media (e.g., hard disk, tape), optical storage media, or the like. To simplify the forgoing discussion, the flash memory or flash memory based SSD is herein used as an exemplary NVM or NV storage device.

An advantage of employing MNS 208 for dividing storages space into multiple LBA base units is that it is more efficient to recycle and/or reallocate the storage space once an NSID is terminated.

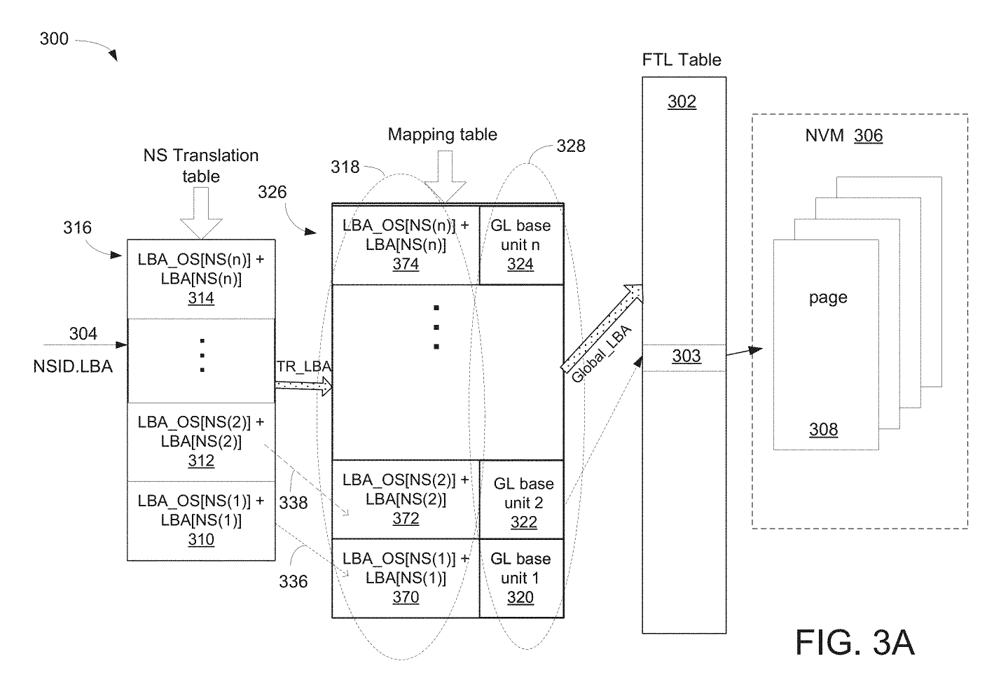

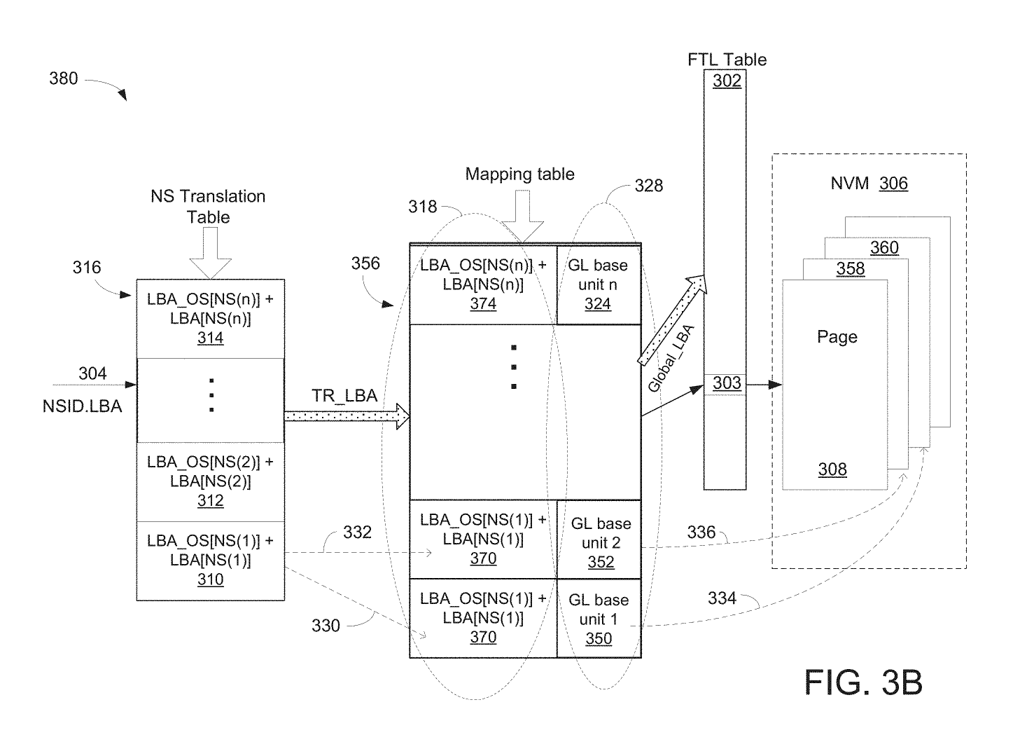

FIG. 3A is a logic block diagram 300 illustrating MNS implementations using tables in accordance with one embodiment of the present invention. Diagram 300 includes an NS translation table 316, mapping table 326, FTL table 302, and NVM 306, wherein NVM 306 is organized in blocks and pages as indicated by numeral 308. A memory controller, in one aspect, uses multiple mapping tables to facilitate MNS via FTL. It should be noted that the underlying concept of the exemplary embodiment(s) of the present invention would not change if one or more blocks (or components) were added to or removed from diagram 300.

NS translation table 316, in one embodiment, includes multiple entries 310-314 wherein each entry stores an LBA offset which, in one example, is used to create a translated LBA based on incoming input with NSID.LBA 304. NSID.LBA 304, for example, is a portion of input indicating identity of namespace and address of input. In one embodiment, NS translation table 316 is a hardware table containing up to 128 rows or entries for storing up to 128 namespaces. Each row or entry of NS translation table 316 includes multiple fields, such as, but not limited to, valid bit, LBA offset, Max_LBA, Advanced Encryption Standard (“AES”) keys, and/or locks. The following table illustrates an exemplary bit allocation to each field.

| Field Name | No. of Bit |
|---|---|
| Valid | 1 |
| Offset | 48 |
| Max_LBA | 48 |
| AES_Key_Valid | 1 |
| AES_Key_Sel | 7 |
| RD_Lock | 1 |
| WR_Lock | 1 |

Upon arrival of incoming input containing data and NSID.LBA 304, a corresponding TR_LBA containing an offset is generated. For example, for an input with NS(1).LBA 304, MNS generates LBA_OS[NS(1)]+LBA[NS(1)] 310, where LBA_OS[NS(1)] indicates LBA offset associated to a first NS. If NS translation table 316 contains 128 entries, MNS is able to handle up to 128 different namespaces which indicate that MNS can have up to 128 VSSDs. It should be noted that this mechanism can be used to translate a single NSID. LBA to a single TR_LBA, or conversely, it can be modified by those of ordinary skills in the art to translate a range of NSID.LBAs to a range of TR_LBAs.

Mapping table or mapping memory 326, in one embodiment, includes multiple entries wherein each entry is divided into two main columns 318 and 328. Mapping table 326, in one example, may include pointers to 1024 global_LBA (“GL”) base units 320-324 wherein GL base units 320-324 have similar or the same size. Column 318, in one aspect, may be an index that is used to select one of the 1024 GL base units. For example, column 318 may contain indexing information to link ranges of TR_LBAs with GL base units. LBA_OS[NS(1)] (LBA offset of namespace one) plus LBA[NS(1) size] 310, for instance, represent a translated LBA, or TR_LBA. The 10 most significant bits of the TR_LBA, for example, may be used as an index to select an entry in the mapping table. The entry in the mapping table such as entry 320 of column 328, in this example, indicates which GL based unit(s) has been assigned to the range of LBAs that include LBA_OS[NS(1)]+LBA[NS(1)] 310.

FTL table 302, in one aspect, is used to provide PPA(s) in view of Global LBAs. A function of FTL table 302 is to generate PPA based on Global LBAs. FTL table 302 can be implemented in DRAM, NVM, or a combination of DRAM and NVM. Upon obtaining PPA, MNS or controller is able to access NVM 308 in accordance with PPA.

NVM 306 is an array of non-volatile storages such as flash memory able to persistently store information. For example, the capacity of NVM 306 can be anywhere from 512 GB to 128 terabytes (“TB”) depending on the applications. In one aspect, the capacity of NVM 306 can be divided into 1024 equal parts. Each GL base unit such as GL base unit 320 is one of the 1024 equal parts of NVM 306. In one embodiment, the most significant 10 bits of the Global LBA indicate which GL base unit the Global LBA is located in. The location within the GL base unit where the Global LBA is found is further derived from the remaining bits of the Global LBA, excluding the most significant 10 bits. The Global LBA is used as an index to select an entry in FTL table 302. The selected entry in FTL table 302 contains a PPA, which points to a fixed location at NVM 306.

In one embodiment, an SSD, containing a controller capable of monitoring and facilitating MNS, includes NS translation table 316, mapping table 326, FTL table 302, and NVM 306. NS translation table 316 includes a set of offsets according to NSID. Mapping table 326 includes a set of GL base units 328. While NS translation table 316 stores offsets for TR_LBAs in response to the incoming packets or input 304, mapping table 326 contains information to locate GL Base unit in FTL based on the high order bits of TR_LBAs. Global LBA is derived by combining GL Base Unit from mapping table 326 with the low order bits of TR_LBA. FTL 302 contains information to locate PPA from Global LBA.

In operation, an MNS process capable of facilitating multiple namespaces receives a memory access request (i.e., read or write operation) with LBA within NSID such as NS(1). Note that the memory access request can be a read or write operation. The NSID.LBA 304 of the memory access request is translated to a TR_LBA using the LBA of NSID and the LBA offset of NSID from NS Translation table 316. After generating a global index based on a portion of bits from TR_LBA such as 10 most significant bits of translated LBA, mapping table 326 is searched or looked up. Upon replacing the portion of bits such as the 10 most significant bits of translated LBA with 10 bits from mapping table 326, a Global LBA is identified. The Global LBA is subsequently used to locate PPA in FTL table 302. The memory access request is executed or carried out based on the PPA.

An advantage of using TR_LBA is that it can handle multiple namespace concurrently using a single physical drive. Another benefit for having a unified capacity for GL base units 320-324 is that it is easier to recycle storage space after an NS is deleted or terminated.

FIG. 3B is a logic block diagram 380 illustrating an MNS implementation using tables in accordance with one embodiment of the present invention. Diagram 380 is similar to diagram 300 except that LBA_OS[NS(1)] 310 requires two GL base units such as units 350-352. Upon identifying large LBA size for NS(1), MNS allocates two GL base units 1-2 350-352 to LBA_OS[NS(1)] as indicated by numerals 330-332. In one aspect, GL base unit 1 in entry 350 of mapping table 356 points to physical block 360 via FTL table 302 as indicated by numeral 334. In addition, LBA_OS[NS(1)] 310 further points to GL base unit 352 which points to NVM block 358 via FTL table 302 as indicated by numeral 336. It should be noted that other ways of assigning and/or mapping multiple base units to one NSID are possible without changing the underlying concept of the presently claimed invention.

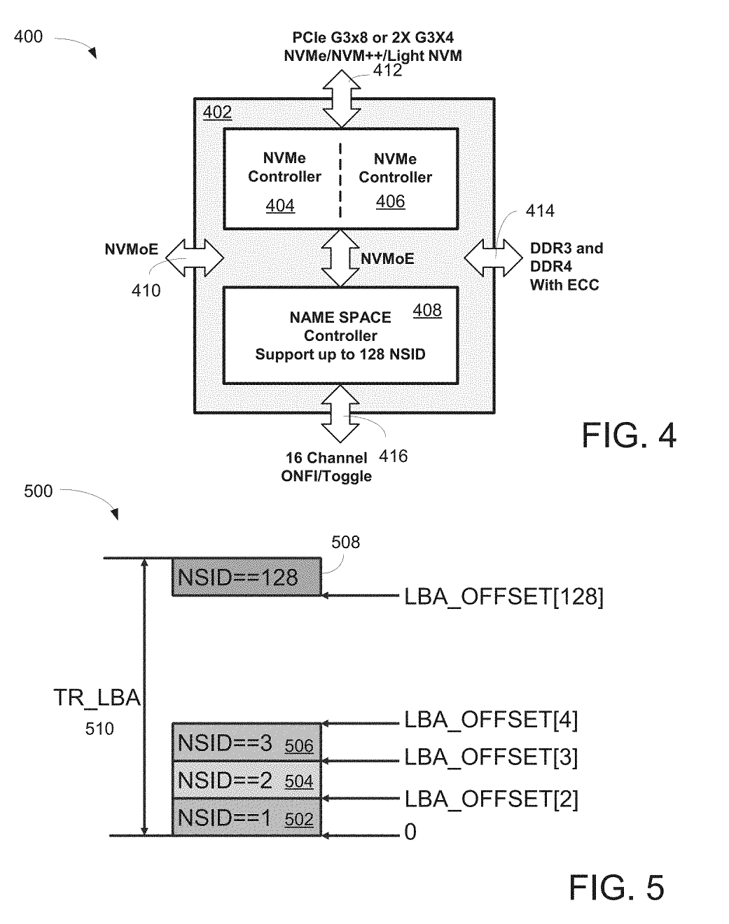

FIG. 4 is a block diagram 400 illustrating an NVM storage controller 402 configured to provide MNS in accordance with one embodiment of the present invention. NVM storage controller 402, in one embodiment, includes NVMe (NVM express) controllers 404-406, NS controller 408, and various peripheral interfaces 410-416. Controllers 404-408 are interconnected via bus(s) using NVMoE (NVM over Ethernet) protocols. It should be noted that the underlying concept of the exemplary embodiment(s) of the present invention would not change if one or more blocks (or components) were added to or removed from diagram 400, or if an interconnect bus other than NVMoE is used.

The memory controller such as NVMe controller 404, in this example, is a PCIe based SSD using NVMe protocol. For example, NVMe Controller 404 or 406 interfaces with PCIe side interface 412 to communicate other devices or hosts. Controller such as NVMe Controller 404 also uses packetized command interface NVMoE to communicate with namespace controller 408. In the case of multi-NS or MNS support, one physical drive is used to emulate multiple independent NS operations.

In one aspect, NVM controller 400 is configured to support up to 128 NSID and/or up to 128 virtual drives or SSDs. Under the NVMe standard, a 32 bit field of NSID is used in submission queue entry. The 32 bit field, in one example, can identify that “0” means NVMe controller itself, “1-n” means a specific Namespace ID, and/or “FFFF_FFFFh” means broadcast such as identifying all commands.

FIG. 5 is a logic diagram 500 illustrating a logic representation of TR_LBA for NSID translation in accordance with one embodiment of the present invention. Diagram 500 illustrates TR_LBA 510 which includes multiple TR_LBA units 502-508. TR_LBA unit 502, for example, is a translated NSID=1 (or NS(1)), and TR_LBA unit 504 is a translated NSID=2 (or NS(2)). LBA offset[2], LBA offset[3], and LBA offset[128], for example, are used to indicate the boundaries between TR_LBA units 502-508. It should be noted that the underlying concept of the exemplary embodiment(s) of the present invention would not change if one or more blocks (or components) were added to or removed from diagram 500.

In one embodiment, a user namespace or NS is mapped into a single translated namespace using a Namespace Mapping table for reducing fragmentation of storage space as well as TR_LBA. For example, one way to implement the mapping table is to construct a table where the NSID is used as an index to select a row in the table. A selected field in the row of the table indicates an offset from the beginning of the TR_LBA space where the user NS begins. For example, LBA_Offset[2] points the beginning of TR_LBA 504.

An advantage of using namespace mapping table is that additional information about the user namespace can be co-stored and/or co-located in the namespace mapping table. For example, the NS mapping table includes information, such as user data block size (e.g. 512B, 4096B, or other block sizes), metadata size, protection information size, format, and location, encryption key identifier (used to identify the NS Global Encryption Key), write protect status of NS, read protect status of NS, a ‘valid’ bit for NS, identity of the reservation holder for NS, type of reservation on NS, offset within the translated NS where the user NS begins, size of the user NS, and the like.

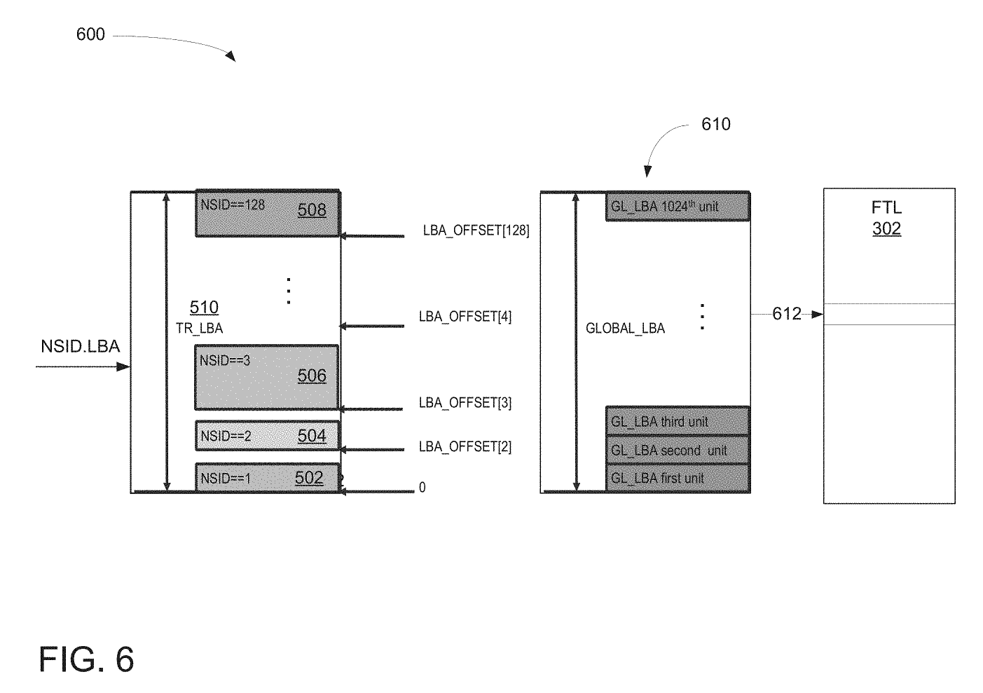

FIG. 6 is a diagram 600 illustrating mapping tables or mapping memory for MNS operation in accordance with one embodiment of the present invention. Diagram 600 illustrates NS translation table 510, mapping table 610, and FTL table 302, wherein mapping table 610 contains GL base units. NS translation table 510, as illustrated in FIG. 5, includes one or more offset for each namespace in units 502-508. It should be noted that the underlying concept of the exemplary embodiment(s) of the present invention would not change if one or more blocks (or components) were added to or removed from diagram 600.

Mapping table 610 includes a range of GL base units wherein the range can be anywhere from 128 to 1024 units. In one embodiment, the storage capacity for each GLS unit or GLS base unit is the same or substantially the same. Each GLS unit can be configured to have a storage capacity anywhere between 64 MB (megabytes) to 8 GB (gigabytes). One advantage of having a unified capacity of GLS base unit is that the base unit is relatively easy to allocate as well as reuse or recycle.

To support one deleted NS to be reused, an indexing scheme, in one aspect, can be implemented which encompasses the following steps: (1) Have a mapping table to map from the TR_LBA value space to a global LBA; (2) a fixed size TR_LBA base unit that can be mapped to the same size GL_LBA base unit; (3) the deleted space of a specific NS in the GL_LBA base unit can be re-used without worrying if it can fit a new NS size or not. This mechanism, in one example, identifies a Namespace Global Encryption Key for the NS. An NVMe device may be required to provide additional keys for LBA ranges within user namespaces. Such ranges can be referred to as LBA locking ranges, and each may require a unique encryption key.

In operation, hardware logic, which could also be implemented in firmware, would scan the LBA Locking Range table to determine if a Read or Write operation falls within an LBA Locking Range. If a ‘hit’ occurs, the Namespace Global Key, if present, would be replaced by a Locking Range key. It should be noted that a namespace may, or may not, have a Global Namespace Encryption Key depending on the applications. For example, if a Namespace has a Namespace Global Encryption Key, but an LBA locking Range within the namespace does not have an encryption key, the LBA range will not be encrypted.

When a user namespace is deleted, unused space or gap may occur in the Translated Namespace. Also, if numerous user namespaces are deleted, then numerous, un-contiguous gaps may be left in the Translated Namespace. These gaps may vary in size, ranging from small to large. It is desirable to concatenate these gaps in Translated Namespace into a single gap, whose size is the sum of the sizes of the un-contiguous gaps. This allows flexibility when re-allocating the unused space in the Translated Namespace to new user namespaces.

Concatenation of ‘holes’ in the Translated Namespace can be accomplished by implementing a mapping table which can also be referred to as a Global LBA Table. The mapping table, in one example, can be located between LBA Locking Range logic and FTL. Such mapping table can be configured to divide the Translated Namespace into a fixed number of segments. For example, the table could be divided into 1024 segments, although the number may be larger or smaller based on different applications. Each segment in the mapping table corresponds to a range of addresses in the Translated Address space. A translated address that falls into a segment in the mapping table is re-directed to a range in a new namespace, referred to as the Global Namespace.

In operation, user namespaces are assigned to offsets within the Translated Namespace or TR_LBA. After mapping the segments of the Translated Namespace to segments of similar size in the Global Namespace, a user NS can occupy 1 or more segments in the Translated Namespace and similarly, can occupy multiple segments in the Global Namespace. There is no limit to the number of segments in the Translated Namespace and Global Namespace that a User Namespace can occupy.

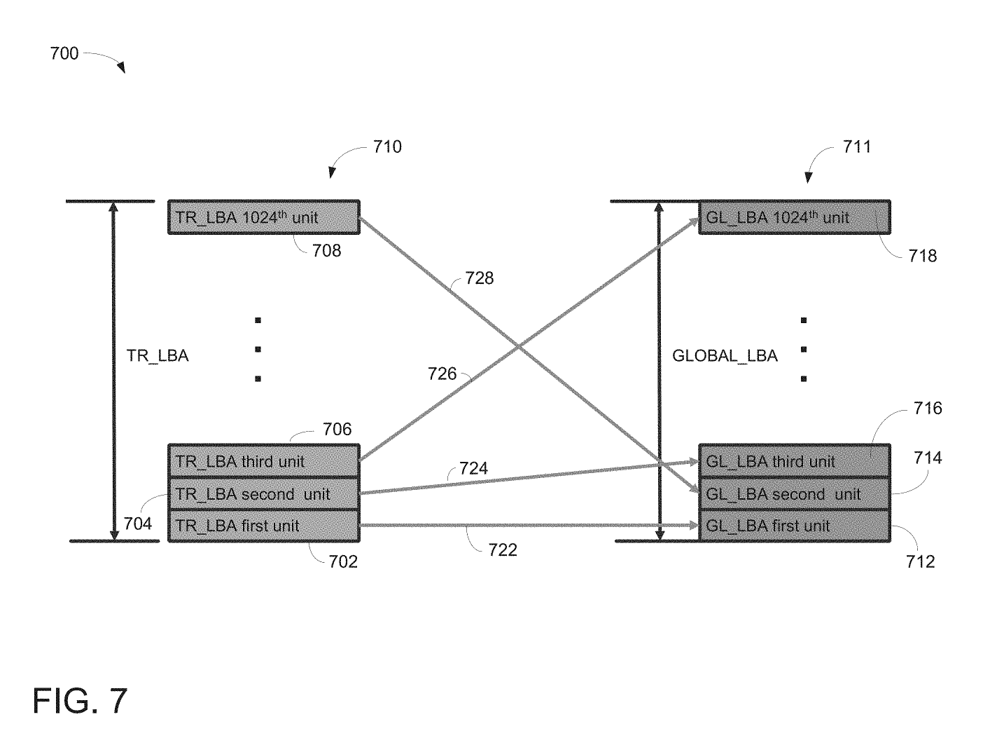

FIG. 7 is a logic diagram 700 illustrating a process of mapping ranges of TR_LBAs to similar ranges of Global LBAs in accordance with one embodiment of the present invention. Diagram 700 illustrates TR_LBA ranges 710 and GLS base units 711 wherein TR_LBA ranges 710 includes multiple TR_LBA ranges 702-708. Global_LBA 711 includes multiple GL-LBA base units 712-718. In one embodiment, multiple mapping tables are used to map or assign TR_LBA ranges 702-708 to GL_LBA base units 712-718 as indicated by arrows 722-728. For example, TR_LBA first range 702 is mapped to GL-LBA first unit 712 as indicated by arrow 722, while TR_LBA second range 704 is mapped to GL-LBA third unit 716 as indicated by arrow 724. TR_LBA third range 706, for example, is mapped to GL-LBA 1024^{th} unit 718 as indicated by arrow 726 and TR_LBA 1024^{th} range 708 is mapped to GL-LBA second unit 714 as indicated by arrow 728. It should be noted that the underlying concept of the exemplary embodiment(s) of the present invention would not change if one or more blocks (or components) were added to or removed from diagram 200.

In global LBA space, the space such as GL_LBA units 712-718 is divided into many of the base units. Each unit can be allocated to a new NS or can be deallocated from a certain NS. When a NS is first time created, it will be mapped to a requested size in a TR_LBA space which is contiguous. TR_LBA space 710 that belongs to the new NS can be allocated using the freed up base units in GL_LBA space 711. When an NS is deleted, that NSID will be deleted from TR_LBA space 710 and the corresponding pointed GL_LBA units will be freed up. Once a GL_LBA base unit of deleted NS is freed up, it can be returned back to GL_LBA space 711 for re-use. The base unit mapping, in one embodiment, allows each GL_LBA base unit to be independently managed and used by one NSID.

It should be noted that the location of a user namespace in the translated namespace is ephemeral, but the location of the user namespace in the global namespace is permanent. Stated in a simpler manner, an LBA in user namespace can point to any location in translated namespace, but that location in translated namespace must always point to the permanent location in global namespace where the user LBA is stored. When a user namespace is deleted, the resulting gap in translated namespace can be moved to a different location in translated namespace by relocating remaining user namespaces to contiguous locations in translated namespace.

During an operation, a process is able to change the offset pointer of the remaining user namespaces in the namespace translation table to point to a new location in the translated namespace. The pointer in the new location in the mapping table is subsequently changed to point to the original, permanent location in the global namespace. Note that by re-arranging translated namespace, gaps in translated namespace can be consolidated into a single region of translated namespace.

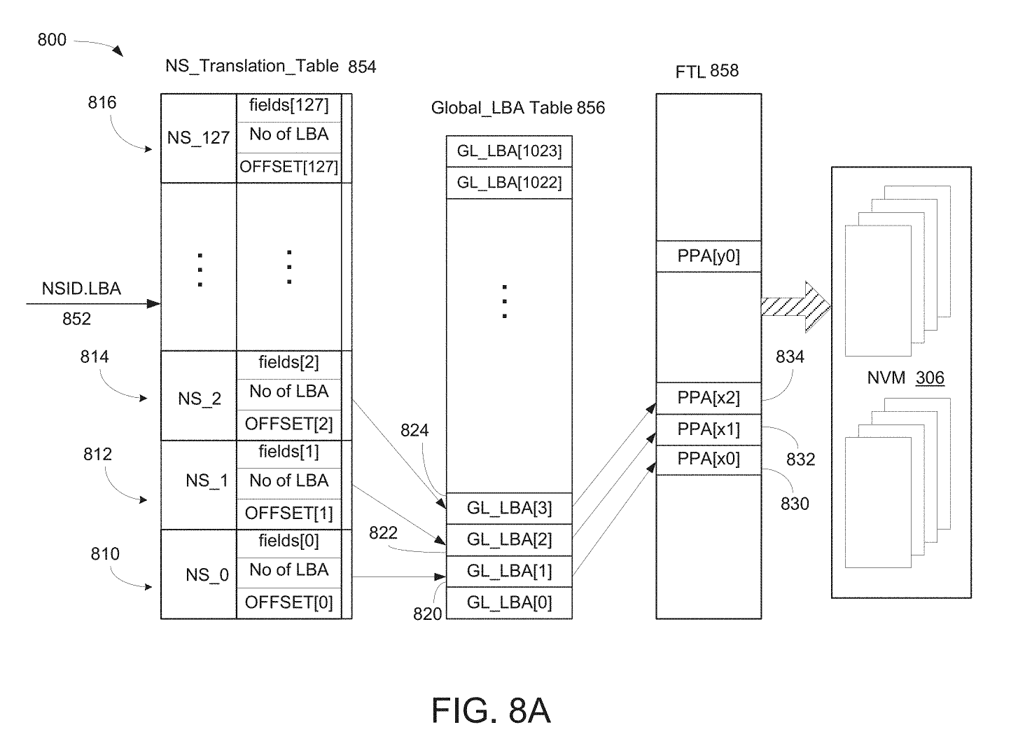

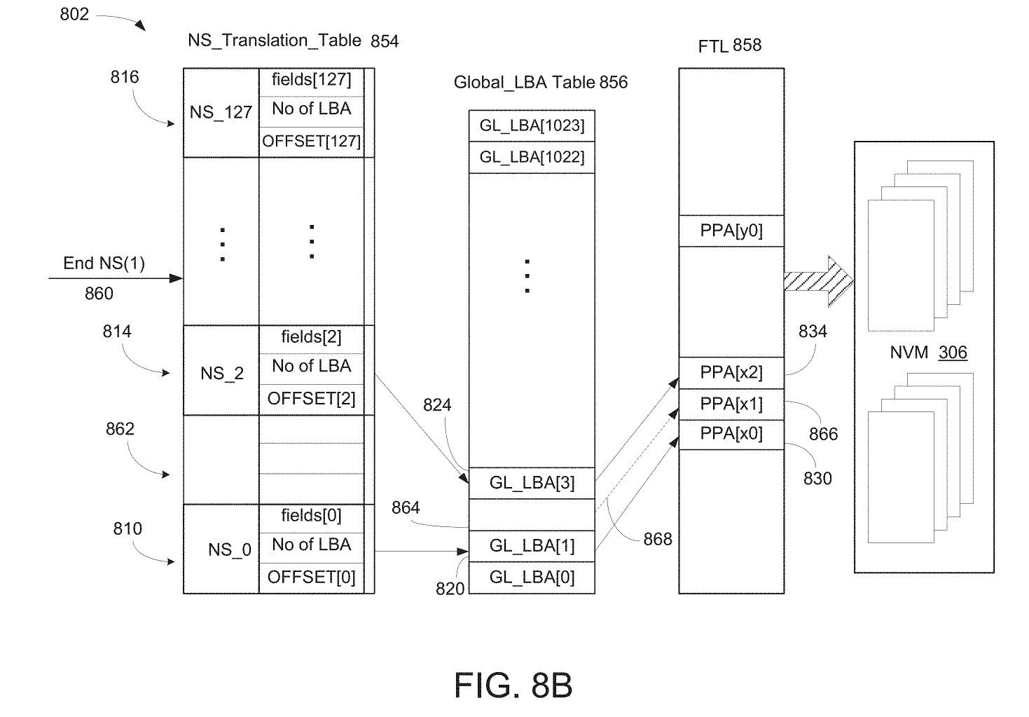

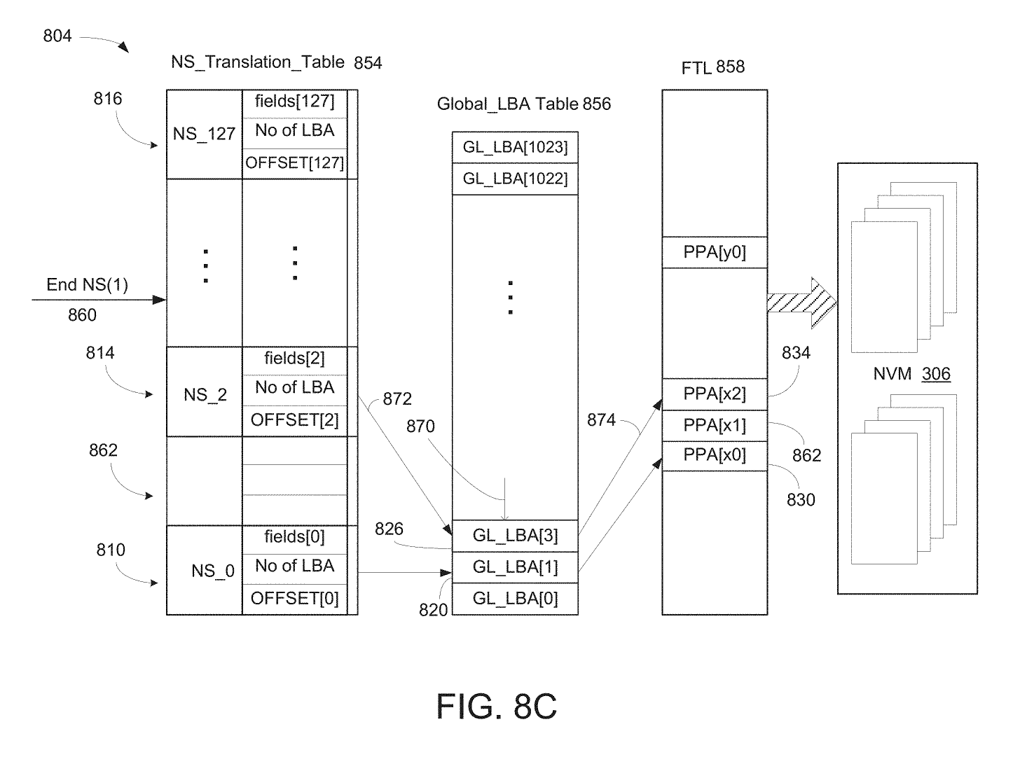

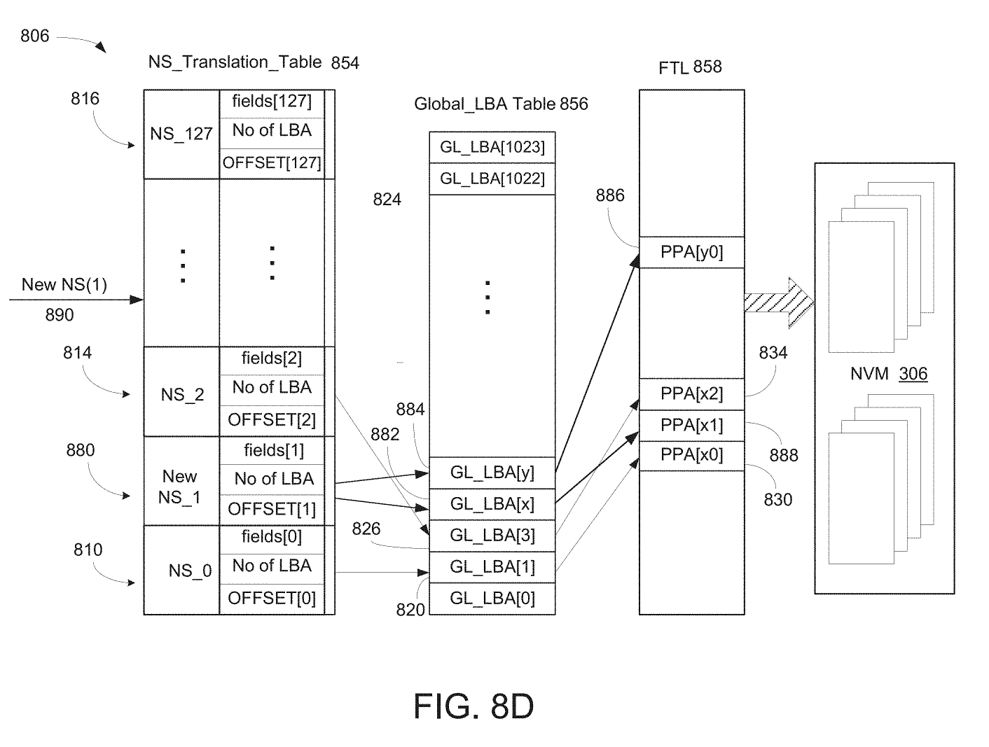

FIGS. 8A-D are logic diagrams illustrating an exemplary process showing an MNS operation including removing an NSID in accordance with one embodiment of the present invention. FIG. 8A shows a logic diagram 800 illustrating an exemplary process showing an MNS operation using multiple tables. Diagram 800 includes an NS translation table 854, mapping table or global_LBA table 856, FTL 858, and NVM 306. NS translation table 854, in one embodiment, includes multiple rows or entries 810-816 wherein each entry represents or stores information relating to a unique namespace. For example, NS(0) (namespace zero) is translated or assigned to entry 810 and NS(1) is translated or allocated to entry 812. Each entry such as entry 810 includes multiple sections, such as offset section, number of LBA section, and fields[x], wherein fields[x] may include validity bit, lock bit(s), and/or encryption bit(s). In one aspect, NS translation table 856 includes a number of entries having a range anywhere from 64 to 256 entries. The number of entries in NS translation table 854, in one embodiment, indicates the number of different namespaces that the MNS controller can handle.

Global_LBA table or mapping table 856, in one embodiment, includes multiple entries wherein each entry stores GL base unit[x], where x is an integer. In one example, x can be 0. In another example, x can be 1023. It should be noted that 1024 GL base units are exemplary number which can be higher or lower but it should not alter the scope of the embodiment. All GL base units, in one example, have the same or similar size or capacity. FTL table 858, in one aspect, includes multiple PPA entries capable of providing physical page address, or PPA, to NVM. A function of FTL table 858 is to generate PPA based on Global LBA. NVM 306 is an array of non-volatile storages such as flash memory able to persistently store information.

In operation, upon receipt of input 852 with multiple NSID.LBAs such as NS(0), NS(1), and NS (2), the MNS controller generates translated LBA using LBA from NSID.LBA and adding offset from an entry in 810-816 as indicated with NS_0, NS_1, and NS_2 which correspond to NS(0), NS(1), and NS(2) respectively. Three GL_LBA entries 820-824 containing GL_LBA[1], GL_LBA[2], and GL_LBA[3] in Global LBA table 856 are assigned or allocated to NS_0, NS_1, and NS_2 respectively, as indicated by arrows. GL_LBA[1], GL_LBA[2], and GL_LBA[3] are used to address or point to PPA range[x0], PPA range[x1], and PPA range [x2] in FTL entries 830-834 of FTL table 858 for identifying physical locations in NVM 306. The memory access (i.e., read or write operation) can be executed or carried out by the MNS controller based on PPA range[x0], PPA range[x1], and PPA range[x2] in FTL entries 830-834.

FIG. 8B is a logic diagram 802 illustrating a continuation of diagram 800 shown in FIG. 8A upon receipt of a command 860 for deleting, ending, or terminating namespace one (1) or NS(1) in accordance with one embodiment of the present invention. The MNS controller, in one embodiment, removes NS_1 from entry 862 of NS translation table 854. Upon deleting NS_1, the original GL_LBA[2] at entry 864 of GL_LBA table or mapping table 856 is subsequently deleted. After removal of GL_LBA[2] from entry 864, the link between entry 864 and PPA range [x1] 866 of FTL table 858 is terminated or delinked as indicated by dotted line 868.

FIG. 8C is a logic diagram 804 illustrating a continuation of diagram 802 shown in FIG. 8B after receipt of a command 860 for deleting, ending, or terminating namespace one (1) or NS(1) in accordance with one embodiment of the present invention. After removal of NS_1 from NS translation table 854 and GL_LBA[2] from GL_LBA table 856, GL_LBA table or mapping table 856 recycles empty GL base unit or reuses used GL base unit by a shifting process. For example, GL_LBA[3] in GL_LBA table 856 is shifted down to occupy the original LB_LBA[2] space as indicated by shifting arrow 870. It should be noted that links 872-874 are shifted together with GL_LBA[3] whereby entries for NS_2 in NS translation table 854 and PPA range [x1] in FTL table 858 remain the same.

FIG. 8D is a logic diagram 806 illustrating a continuation of diagram 804 shown in FIG. 8C after a shifting process in accordance with one embodiment of the present invention. Upon receipt of input 890 creating a new namespace, such as new NS(1), the MNS controller generates a new NS_1 in entry 880. Since the new NS_1 requires two (2) GL_LBA base units to carry out the memory storage requirement, two GL_LBA entries 882-884 containing GL_LBA[x] and GL_LBA[y] in Global_LBA table 856 are assigned or allocated to the new NS_1 as indicated by arrows. GL_LBA[x] and GL_LBA[y] are used to address or point to PPA range [x1] and PPA range [y0] in FTL entries 886-888 of FTL table 858 for identifying physical locations in NVM 306. The memory access (i.e., read or write operation) can be executed or carried out by MNS operation based on PPA selected from PPA range [x1] or PPA range[y0] in FTL entries 886-888 as indicated by Global LBA.

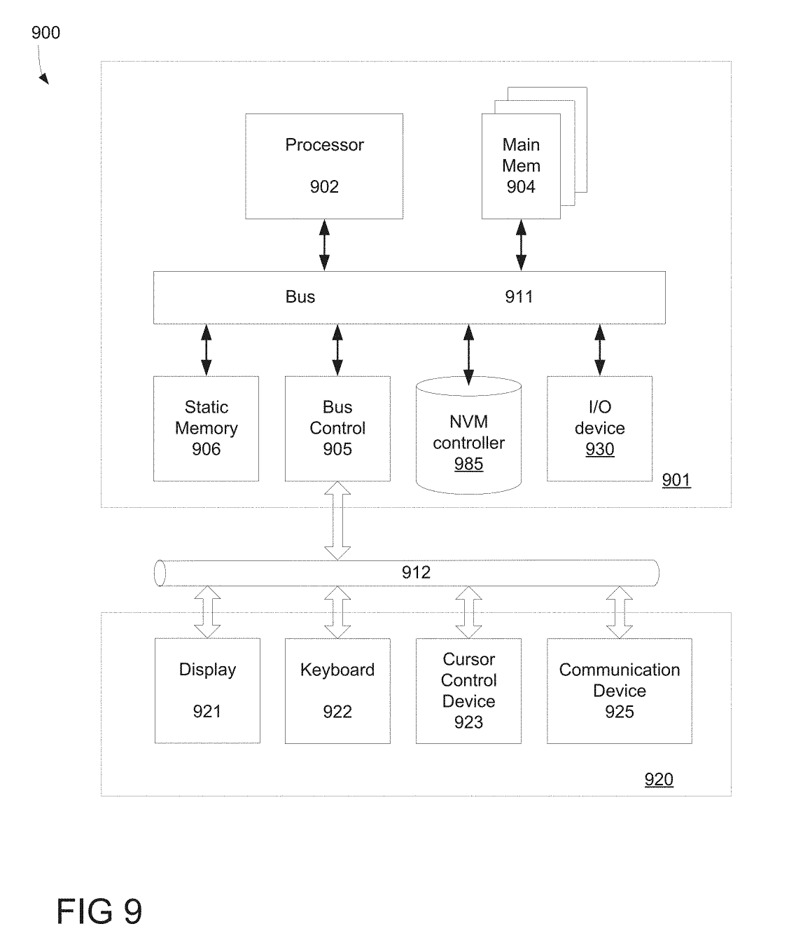

Having briefly described one embodiment of the memory operation(s) in which the embodiment(s) of the present invention operates, FIG. 9 illustrates an example of a digital processing device or system 900 which can be a memory controller, server, a router, a switch, a node, a hub, a wireless device, or a computer system.

FIG. 9 is a block diagram illustrating a digital processing system capable of providing MNS operation in accordance with one embodiment of the present invention. Computer system or a signal processing system 900 can include a processing unit 901, an interface bus 912, and an input/output (“TO”) unit 920. Processing unit 901 includes a processor 902, a main memory 904, a system bus 911, a static memory device 906, a bus control unit 905, an I/O element 930, and a NVM controller 985. It should be noted that the underlying concept of the exemplary embodiment(s) of the present invention would not change if one or more blocks (circuit or elements) were added to or removed from FIG. 9.

Bus 911 is used to transmit information between various components and processor 902 for data processing. Processor 902 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 904, which may include multiple levels of cache memories, stores frequently used data and instructions. Main memory 904 may be RAM (random access memory), MRAM (magnetic RAM), or flash memory. Static memory 906 may be a ROM (read-only memory), which is coupled to bus 911, for storing static information and/or instructions. Bus control unit 905 is coupled to buses 911-912 and controls which component, such as main memory 904 or processor 902, can use the bus. Bus control unit 905 manages the communications between bus 911 and bus 912. Mass storage memory or SSD 106, which may be a magnetic disk, an optical disk, hard disk drive, floppy disk, CD-ROM, and/or flash memories are used for storing large amounts of data.

I/O unit 920, in one embodiment, includes a display 921, keyboard 922, cursor control device 923, and communication device 925. Display device 921 may be a liquid crystal device, cathode ray tube (“CRT”), touch-screen display, or other suitable display device. Display 921 projects or displays images of a graphical planning board. Keyboard 922 may be a conventional alphanumeric input device for communicating information between computer system 900 and computer operator(s). Another type of user input device is cursor control device 923, such as a conventional mouse, touch mouse, trackball, or other type of cursor for communicating information between system 900 and user(s).

Communication device 925 is coupled to bus 911 for accessing information from remote computers or servers, such as server 104 or other computers, through wide-area network 102. Communication device 925 may include a modem or a network interface device, or other similar devices that facilitate communication between computer 900 and the network. Computer system 900 may be coupled to a number of servers via a network infrastructure for performing as a network system.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

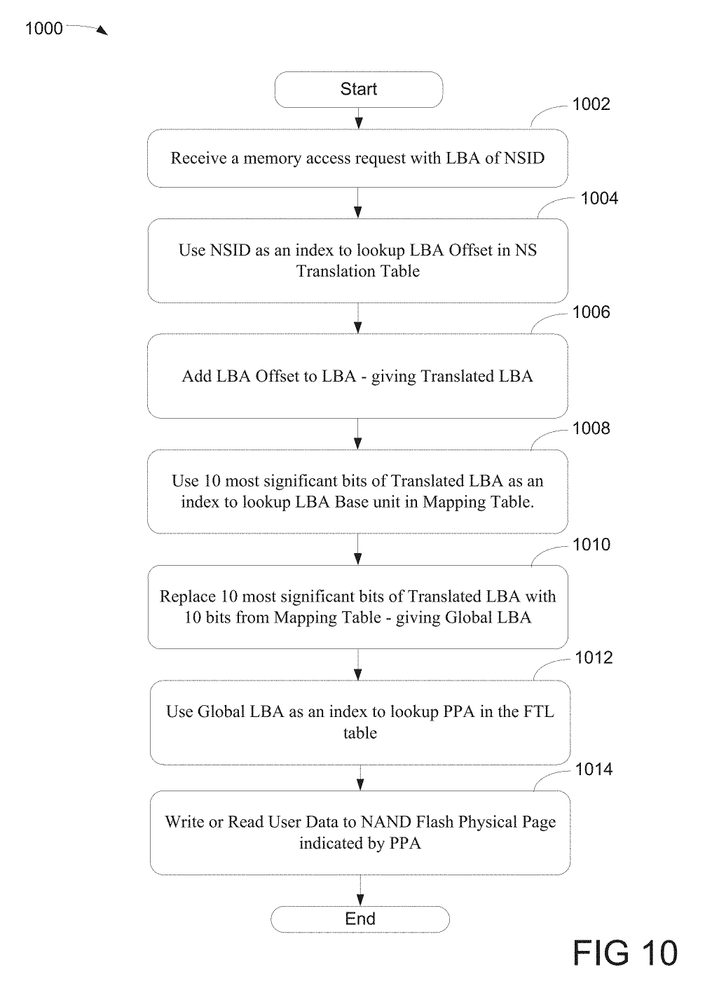

FIG. 10 is a flow diagram 1000 illustrating an operation of MNS using memory mapping in accordance with one embodiment of the present invention. At block 1002, a process capable of facilitating multiple NS s in SSD using FTL receives a memory access request with LBA within a first NSID (i.e., NS(1)). It should be noted that the memory access request can be a write request, read request, refresh request, delete request, and the like.

At block 1004, upon looking up a first LBA offset in an NS translation table according to the first NSID, a first TR_LBA, at block 1006, is generated based on the first LBA offset. To produce a first translated LBA, the first LBA offset, for instance, is added to the first LBA.

At block 1008, a first LBA base unit is identified in the mapping table in accordance with at least a portion of bits in the first TR_LBA. For example, the ten (10) most significant bits of first TR_LBA is used to generate an index which is used to lookup GL base unit in the mapping table.

At block 1010, the process, in one embodiment, replacing ten (10) most significant bits of first TR_LBA with ten (10) bits from the mapping table to generate a first global LBA. At block 1012, a first PPA is obtained from FTL table using the global LBA as index.

At block 1014, the process performs or executes the first memory access request according to the first PPA. It should be noted that the first memory access request may include writing user data to a flash memory page indicated by the first PPA. In one embodiment, after receiving a second memory access request with an LBA within a second NSID (ie, NS(2)), the process looks up a second LBA offset in the NS translation table in response to the second NSID. Upon generating a second TR_LBA based on the second LBA offset, a second GL base unit is identified in the mapping table in accordance with a second index which is generated from ten (10) most significant bits of the second TR_LBA. A second PPA is subsequently obtained in the FTL table in response to the second global LBA.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method for facilitating multiple namespaces (“NSs”) in a solid state drive (“SSD”) via flash translation layer (“FTL”), comprising:
receiving a first memory access request with a logical block address (“LBA”) within a first namespace identifier (“NSID”);
identifying a first LBA offset in accordance with the first NSID and generating a first translated LBA (“TR_LBA”) in response to the first LBA offset;
looking up a global LBA (“GL”) base unit in a mapping table based on the first TR_LBA;
receiving a second memory access request with an LBA within a second NSID; and
identifying a second LBA offset in accordance with the second NSID and generating a second TR_LBA in response to the second LBA offset.

2. The method of claim 1, further comprising identifying a first GL base unit in the mapping table in accordance with an index generated from a portion of bits of the first TR_LBA.

3. The method of claim 2, further comprising identifying a first global LBA address including the first GL base unit in the mapping table and a portion of bits in the first TR_LBA.

4. The method of claim 3, further comprising identifying a first physical page address (“PPA”) in a flash translation layer (“FTL”) table in response to the first global LBA address.

5. The method of claim 4, further comprising processing the first memory access request in accordance with first physical page address (“PPA”) stored in the flash translation layer (“FTL”).

6. The method of claim 1, further comprising identifying a second GL base unit from the second TR_LBA; identifying a second Global LBA from the second GL base unit and a portion of bits from the second TR_LBA; identifying a second physical page address (“PPA”) in a flash translation layer (“FTL”) based on the second global LBA; and processing the second memory access request in accordance with the second physical page address (“PPA”).

7. The method of claim 1, further comprising removing the first NSID from the translation lookup table in response to receipt of a deletion command for deleting the first NSID.

8. The method of claim 7, further comprising:
shifting entries of the mapping table to recover LBA address space; and
updating mapping memory to reflect removal of the first NSID.

9. The method of claim 1, wherein receiving a first memory access request includes receiving a write command from a host.

10. The method of claim 1, further comprising:
looking up a GL base unit in the mapping table based on the second TR_LBA; and
identifying a second GL base unit in the mapping table in accordance with an index generated from a portion of bits of the first TR_LBA.

11. The method of claim 10, further comprising identifying a second PPA in the FTL table in response to the second GL base unit and a portion of bits of the second TR_LBA.

12. An apparatus configured to store information persistently, comprising:
a translation table containing multiple entries wherein each entry stores information relating to translation between an incoming logical block address (“LBA”) with namespace identifiers (“NSIDs”) and a translated LBA (“TR_LBA”);
a mapping table coupled to the translation table and configured to have multiple global entries, wherein each global entry stores a global LBA (“GL”) base unit; and
a flash translation layer (“FTL”) table coupled to the mapping table and configured to have multiple FTL entries, wherein each FTL entry includes a physical page address (“PPA”) indexed by a global LBA.

13. The apparatus of claim 12, further comprising a non-volatile memory (“NVM”) storage device capable of being addressed by a PPA stored in the FTL table.

14. The apparatus of claim 12, wherein the GL base units are organized in such a way that each GL base unit maps the same or substantially same storage capacity.

15. The apparatus of claim 12, wherein the translation table is an NS translation table capable of storing up to 128 or more NSIDs.

16. A solid state drive (“SSD”) capable of facilitating multiple namespaces for data storage comprising the apparatus of claim 12.

17. A method for facilitating multiple namespaces (“NSs”) in a solid state drive (“SSD”) via flash translation layer (“FTL”), comprising:
receiving a first memory access request with a logical block address (“LBA”) within a first namespace identifier (“NSID”);
looking up first LBA offset in an NS translation table in response to the first NSID and generating a first translated LBA (“TR_LBA”) based on the first LBA offset;
identifying a first global LBA (“GL”) base unit in a mapping table in accordance with an index generated from a portion of bits of the first TR_LBA; and
obtaining a first physical page address (“PPA”) in a flash translation layer (“FTL”) table in response to the first GL base unit and a portion of bits of the first TR_LBA.

18. The method of claim 17, further comprising performing the first memory access request in accordance with the first PPA.

19. The method of claim 18, wherein the first memory access request includes writing user data to a flash memory page indexed by the first PPA.

20. The method of claim 17,
wherein identifying a first GL base unit includes generating an index based on ten (10) most significant bits of first TR_LBA; and
wherein obtaining a first physical page address (“PPA”) in a flash translation layer (“FTL”) table includes replacing ten (10) most significant bits of first TR_LBA with ten (10) bits from the mapping table to generate a first global LBA.

21. The method of claim 17, further comprising:
receiving a second memory access request with an LBA within a second NSID;
looking up second LBA offset in the NS translation table in response to the second NSID and generating a second TR_LBA based on the second LBA offset;
identifying a second GL base unit in the mapping table in accordance with a second index generated from ten (10) most significant bits of the second TR_LBA; and
obtaining a second PPA in the FTL table in response to the second
gl base unit and a portion of bits of the second TR_LBA.

22. A method for facilitating multiple namespaces (“NSs”) in a solid state drive (“SSD”) via flash translation layer (“FTL”), comprising:
translating the LBA of the first NSID to a first translated LBA (“TR_LBA”) based on the first LBA of the first NSID and the LBA offset obtained from the NS translation table entry associated with the first NSID;
identifying a first entry in a mapping table in accordance with a portion of bits of the first TR_LBA and obtaining a first global LBA (“GL”) base unit from the mapping table;
obtaining a first physical page address (“PPA”) in a flash translation layer (“FTL”) table in response to the first GL base unit and a portion of bits of the first TR_LBA; and
performing the first memory access request in accordance with the first PPA.

23. The method of claim 22, further comprising;
receiving a second memory access request with an LBA within a second NSID; and
translating the LBA of the second NSID to a second translated LBA (“TR_LBA”) based on the second NSID and the second LBA offset;

24. The method of claim 23, further comprising obtaining a second global LBA (“GL”) base unit from the mapping table; obtaining a second physical page address (“PPA”) in a flash translation layer (“FTL”) table in response to the second GL base unit and a portion of bits of the second TR_LBA; and performing the second memory access request in accordance with the second PPA.

25. The method of claim 22, further comprising removing the first NSID from the translation lookup table in response to receipt of a deletion command for deleting the first NSID.

26. The method of claim 22, wherein recording a first global LBA base unit includes generating an global index based on ten (10) most significant bits of first TR_LBA and replacing ten (10) most significant bits of first TR_LBA with ten (10) bits from the mapping table to generate a first global LBA base unit.
